(19) United States
(12) Patent Application Publication
(10) Pub. No.: US 2019/0373822 A1
(43) Pub. Date: Dec. 12, 2019

(54) Collapsible Mulch Dispenser

(71) Applicant: Ned A Hamad, JR., Strongsville, OH (US)

(72) Inventor: Ned A Hamad, JR., Strongsville, OH (US)

(21) Appl. No.: 16/153,498

(22) Filed: Oct. 5, 2018

Related U.S. Application Data
(60) Provisional application No. 62/683,947, filed on Jun. 12, 2018.

(51) Int. Cl. A01G 13/02; B05B 7/14

(52) U.S. Cl. CPC A01G 13/0287; B05B 7/144

(57) ABSTRACT

A collapsible mulch dispenser has a collapsible hopper, a blower assembly, and a motor. The collapsible hopper is a freestanding receptacle that has a collapsible frame, a container, an outlet and a declined surface. The container is a bag that is mounted within the collapsible frame so that mulch can be poured into the container to be dispensed through the outlet. The declined surface is mounted within the container and forms a slope that directs the contents of the container to pass through the outlet. The blower assembly is a system used to deposit the mulch onto a desired surface. Accordingly, the motor and the blower assembly are coupled to the out so that mulch can flow out of the container and through the blower assembly.

The current application claims a priority to the U.S. Provisional Patent application Ser. No. 62/683,947 filed on Jun. 12, 2018.

### FIELD OF THE INVENTION

The present invention relates generally to landscaping equipment. More specifically, the present invention is a combination of a collapsible mulch bag and a mulch blower.

### BACKGROUND OF THE INVENTION

In present society, landscaping is of great importance. Through landscaping, the user can maintain the aesthetics of the outdoor environment surrounding buildings, within parks, and other similar locations. Landscaping incorporates many factors from planting trees and flowers to trimming branches and bushes. An equally important factor is the laying down of mulch. There do exists mulch blowers to speed up the process of laying down mulch, especially for large areas including, but not limited to, commercial office parks and recreational areas. However, these devices are often bulky and cumbersome. Also, these devices are not easily storable.

An objective of the present invention is to provide users with a combination of a collapsible mulch bag and mulch blower. The present invention provides users with a mulch bag that can be compressed for transport or storage. Additionally, the present invention provides users with a freestanding mulch bag and mulch blower system. The present invention is designed to function as a mulch bag that can receive mulch from a delivery truck. Additionally, the mulch bag can be used to supply mulch to a variety of mulch blower systems.

The present invention is a combination of a collapsible mulch bag and a mulch blower. The collapsible mulch bag contains a collapsible frame. The collapsible mulch bag contains a declined slope in the cavity of the collapsible mulch bag. The collapsible mulch bag contains a hole on the side that is closest to the lower end of the declined slope. The collapsible mulch bag is connected to the mulch blower by a coupler. The mulch blower contains two blower motors connected to the coupler. The coupler directs a stream of mulch out of the mulch blower to a hose. The hose can be made of a plurality of hose segments that can be connected together by couplers. The free end of the hose contains an ergonomic nozzle with a control panel.

### BRIEF DESCRIPTION OF THE DRAWINGS

FIG. 1 is a perspective view of the present invention.

FIG. 2 is a front view of the present invention.

FIG. 3 is a left-side sectional view of the present invention taken along line 3-3 in FIG. 2. In this view the flow of the stream of mulch is indicated by a bold arrow.

FIG. 4 is a perspective view of the collapsible hopper used in the present invention.

FIG. 5 is perspective view of the present invention with the manifold housing removed.

### DETAIL DESCRIPTIONS OF THE INVENTION

All illustrations of the drawings are for the purpose of describing selected versions of the present invention and are not intended to limit the scope of the present invention.

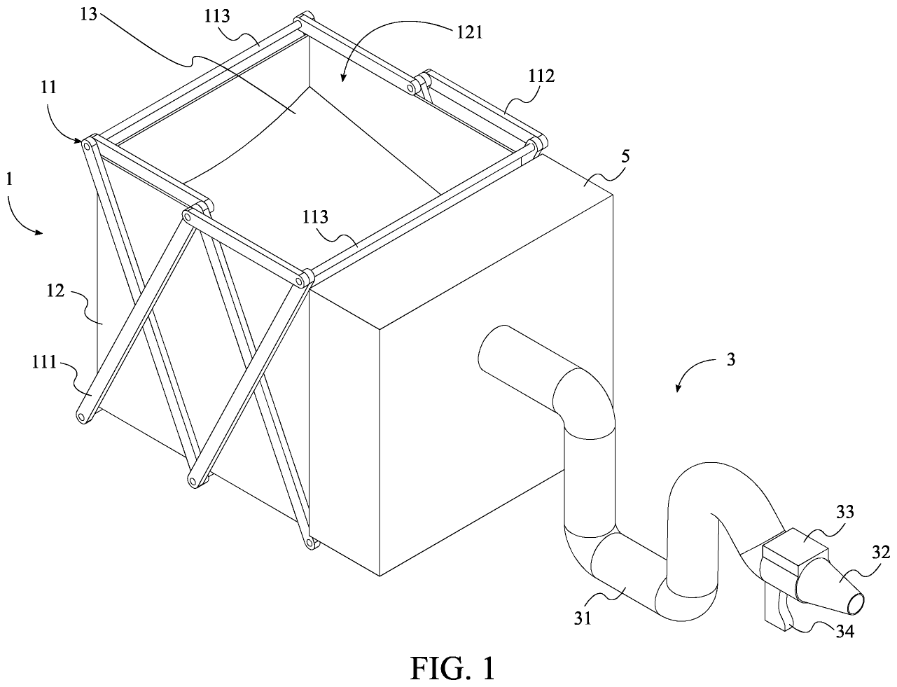

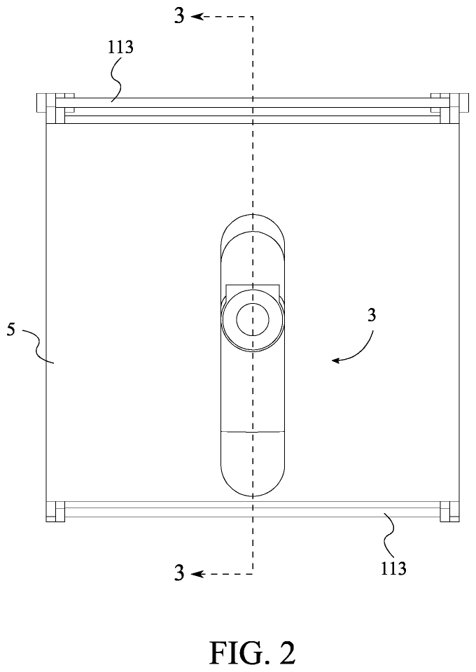

Referring to FIG. 1 through FIG. 5, the present invention, the collapsible mulch dispenser, is a system for storing and dispensing particulate matter while performing landscaping operations. Additionally, the present invention is designed with a collapsible structure that enables a user to quickly store and transport the present invention while not in use. To achieve this functionality, the present invention comprises a collapsible hopper 1, a blower assembly 3, and at least one motor 4. The collapsible hopper 1 comprises a collapsible frame 11, a container 12, dispenser outlet 14 and a declined surface 13. Preferably, the container 12 is a flexible bag. Additionally, the container 12 is mounted within the collapsible frame 11. As a result, the collapsible hopper 1 is able to be transitioned from a collapsed configuration when stored to an expanded configuration when deployed. Specifically, the container 12 is held open while the collapsible frame 11 is in the expanded configuration. Additionally, the collapsible frame 11 and the container 12 work in concert to function as a freestanding receptacle into which mulch can be deposited. Conversely, the container 12 is compressed within the collapsible frame 11 while the collapsible frame 11 is in the collapsed configuration. The dispenser outlet 14 is integrated into the container 12 so that mulch stored within the container 12 can be dispensed as required. The declined surface 13 is mounted within an interior compartment 121 of the container 12. Additionally, the declined surface 13 is angled toward the dispenser outlet 14. Thus positioned, the declined surface 13 forms a sloped plane within the container 12 that funnels the stored mulch toward the dispenser outlet 14. That is, the declined plane acts as a conveyor system that delivers the mulch within the container 12 to the dispenser outlet 14.

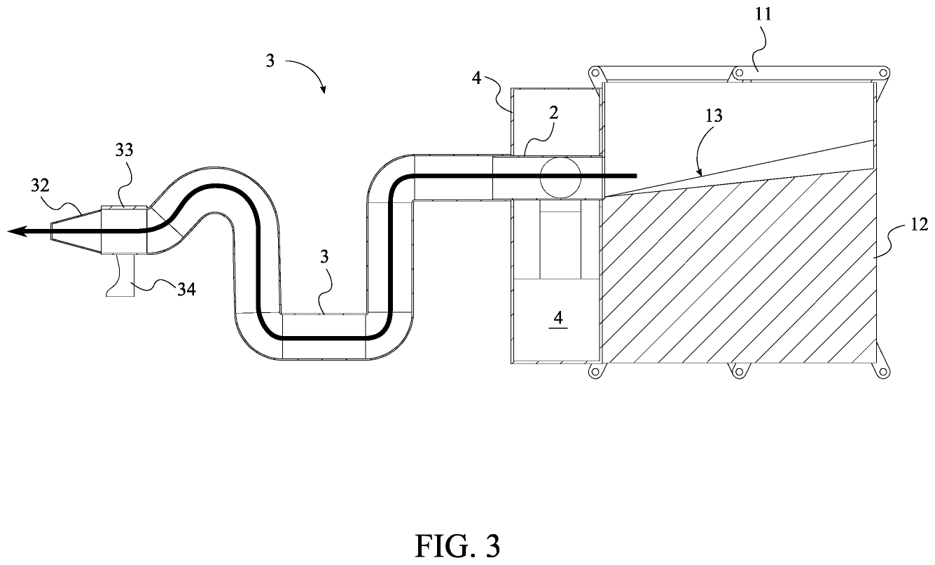

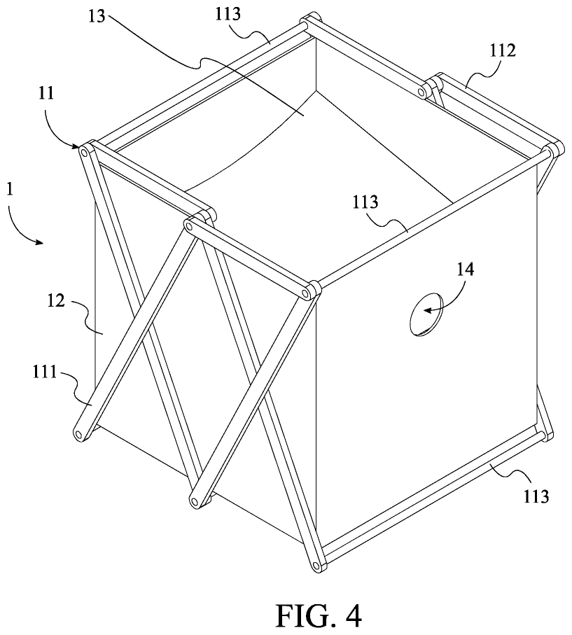

Referring to FIG. 3 and FIG. 4, the present invention is designed to be employed while performing a wide variety of landscaping activities. To that end, the blower assembly 3 is a system that enables the user to direct the flow of a stream of mulch out of the collapsible hopper 1 and onto a desired area. To accomplish this, the blower assembly 3 is in fluid communication with the interior compartment 121 through the dispenser outlet 14. Additionally, the motor 4 is operatively coupled to the blower assembly 3 and the interior compartment 121, wherein the motor 4 causes a material stored within the container 12 to be forced through the blower assembly 3. As a result, the motor 4 draws the stream of mulch out of the container 12 through the dispenser outlet 14. The motor 4 further forces the stream of mulch through the blower assembly 3. Thus, enabling a user to deposit the stream of mulch onto the desired area.

Referring to FIG. 1 and FIG. 4, the collapsible frame 11 is an articulated frame that comprises a first scissoring strut assembly 111, a second scissoring strut assembly 112, and a plurality of bracing ties 113. The first scissoring strut assembly 111 is positioned offset from the second scissoring strut assembly 112. Additionally, the plurality of bracing ties 113 is connected in between the first scissoring strut assembly 111 and the second scissoring strut assembly 112. As a result, the first scissoring strut assembly 111 and the second scissoring strut assembly 112 are able to form a freestanding structure while the collapsible frame 11 is in the expanded configuration. The container 12 is mounted in between the first scissoring strut assembly 111 and the second scissoring strut assembly 112. Additionally, the plurality of bracing ties 113 is distributed about the container 12. Accordingly, the plurality of bracing ties 113 protects the container 12 from damage caused by excessive loads and external hazards.

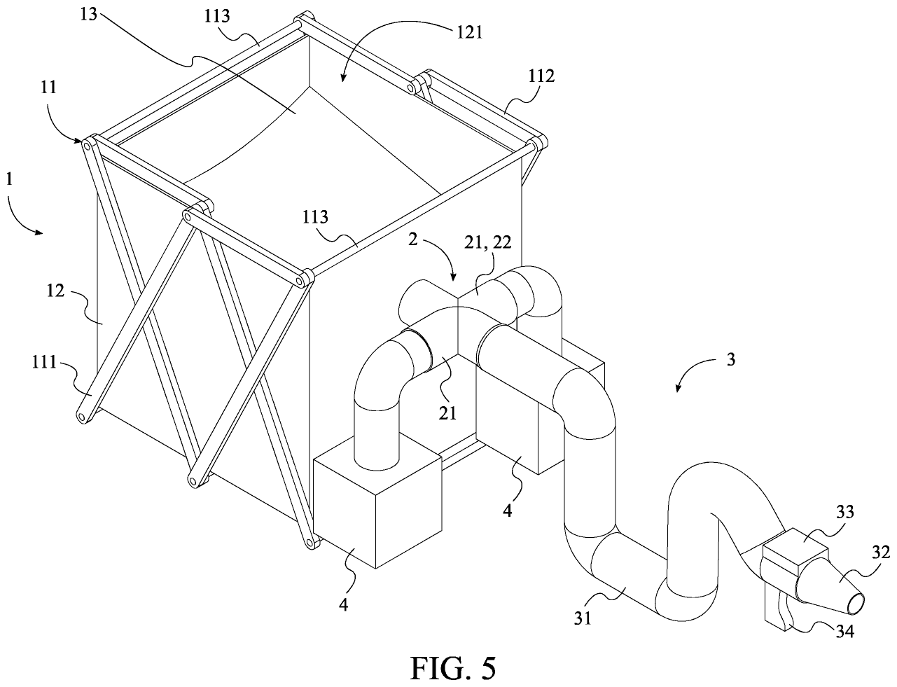

Referring to FIG. 1, FIG. 4, and FIG. 5, the present invention is designed to transfer forces generated by the motor 4 into the mulch, such that the stream of mulch is directed out of the interior compartment 121 through the dispenser outlet 14. To accomplish this, the present invention further comprises a feed manifold 2. The feed manifold 2 is mounted in between, the dispenser outlet 14, the blower assembly 3, and the at least one motor 4. Additionally, the interior compartment 121 and the motor 4 are in fluid communication with the blower assembly 3 through the feed manifold 2. Accordingly, the feed manifold 2 enables the motor 4 to force the stream of mulch out of the interior compartment 121 and through the blower assembly 3. Preferably, the at least one motor 4 is a plurality of motors 4 and the feed manifold 2 comprises a plurality of motor inlets 21. The plurality of motor inlets 21 is integrated into the feed manifold 2. Additionally, each of the plurality of motors 4 is in fluid communication with the feed manifold 2 through a corresponding inlet 22 from the plurality of motor inlets 21. Consequently, each of the plurality of motors 4 works in concert to propel the stream of mulch. The present invention further comprises a manifold housing 5. The manifold housing 5 is laterally mounted onto the collapsible frame 11. Additionally, the feed manifold 2 and the motor 4 are mounted within the manifold housing 5. Accordingly, the manifold housing 5 protects the feed manifold 2 and the motor 4 from environmental hazards.

Referring to FIG. 1 and FIG. 4, the present invention is designed with a blower assembly 3 that enables the user to dispense a precision stream of mulch. To that end, the blower assembly 3 comprises a hose 31, a nozzle 32, a motor control system 33, and a handgrip 34. Additionally, the hose 31 is terminally coupled to the dispenser outlet 14. Accordingly, the stream of mulch is able to exit the interior compartment 121 through the dispenser outlet 14 and then flow through the hose 31. The nozzle 32 is terminally mounted onto the hose 31, opposite to the dispenser outlet 14. Additionally, the dispenser outlet 14 is in fluid communication with the nozzle 32 through the hose 31. As a result, the nozzle 32 enables the user to accurately direct the stream of mulch being dispensed. The motor control system 33 is also terminally mounted onto the hose 31, opposite to the dispenser outlet 14. Additionally, the motor control system 33 is communicably coupled to the motor 4. As a result, the user is able to govern the operation of the motor 4 by interacting with the motor control system 33. Preferably, the motor control system 33 includes a microcontroller and user interface device that enable the user to issue commands to the motor 4 through the motor control system 33. The handgrip 34 is laterally mounted onto the hose 31 and positioned offset from the dispenser outlet 14 along the hose 31. Thus, the handgrip 34 is advantageously positioned to enable the user to maneuver the hose 31 and the nozzle 32.

Although the invention has been explained in relation to its preferred embodiment, it is to be understood that many other possible modifications and variations can be made without departing from the spirit and scope of the invention as hereinafter claimed.

What is claimed is:

1. A collapsible mulch dispenser comprising:
a collapsible hopper;
a blower assembly;
at least one motor;
the collapsible hopper comprising a collapsible frame, a container, a dispenser outlet, and a declined surface;
the container being mounted within the collapsible frame;
the dispenser outlet being integrated into the container;
the declined surface being mounted within an interior compartment of the container;
the declined surface being angled toward the dispenser outlet;
the blower assembly being coupled the dispenser outlet, external to the interior compartment;
the blower assembly being in fluid communication with the interior compartment through the dispenser outlet; and
the motor being operatively coupled to the blower assembly and the interior compartment, wherein the motor causes a material stored within the container to be forced through the blower assembly.

2. The collapsible mulch dispenser as claimed in claim 1 comprising:
the collapsible frame comprising a first scissoring strut assembly, a second scissoring strut assembly, and a plurality of bracing ties;
the first scissoring strut assembly being positioned offset from the second scissoring strut assembly;
the container being mounted in between the first scissoring strut assembly and the second scissoring strut assembly;
the plurality of bracing ties being connected in between the first scissoring strut assembly and the second scissoring strut assembly; and
the plurality of bracing ties being distributed about the container.

3. The collapsible mulch dispenser as claimed in claim 1 comprising:
a feed manifold;
the feed manifold being mounted in between, the dispenser outlet, the blower assembly, and the at least one motor; and
the interior compartment and the motor being in fluid communication with the blower assembly through the feed manifold.

4. The collapsible mulch dispenser as claimed in claim 3 comprising:
the at least one motor being a plurality of motors;
the feed manifold comprising a plurality of motor inlets;
the plurality of motor inlets being integrated into the feed manifold; and
each of the plurality of motor inlets being in fluid communication with the feed manifold through a corresponding inlet from the plurality of motor inlets.

5. The collapsible mulch dispenser as claimed in claim 3 comprising:
a manifold housing;
the manifold housing being laterally mounted onto the collapsible frame; and
the feed manifold and the motor being mounted within the manifold housing.

6. The collapsible mulch dispenser as claimed in claim 1 comprising:
the blower assembly comprising a hose; and
the hose being terminally coupled to the dispenser outlet.

7. The collapsible mulch dispenser as claimed in claim 6 comprising:
the blower assembly further comprising a nozzle;
the nozzle being terminally mounted onto the hose, opposite to the dispenser outlet; and
the dispenser outlet being in fluid communication with the nozzle through the hose.

8. The collapsible mulch dispenser as claimed in claim 6 comprising:
the blower assembly further comprising a motor control system;
the motor control system being terminally mounted onto the hose, opposite to the dispenser outlet; and
the motor control system being communicably coupled to the motor.

9. The collapsible mulch dispenser as claimed in claim 6 comprising:
the blower assembly further comprising a handgrip;
the handgrip being laterally mounted onto the hose; and
the handgrip being positioned offset from the dispenser outlet along the hose.

10. The collapsible mulch dispenser as claimed in claim 1 comprising, wherein the container is a bag.
